(19) United States
(12) Patent Application Publication
(10) Pub. No.: US 2026/0094746 A1
(43) Pub. Date: Apr. 2, 2026

(54) Magnetorheological Fluid And Braking Device

(71) Applicant: SEIKO EPSON CORPORATION, Tokyo (JP)

(72) Inventor: Shigeki KAWADA, Shiojiri (JP)

(21) Appl. No.: 19/341,031

(22) Filed: Sep. 26, 2025

(30) Foreign Application Priority Data
Sep. 27, 2024 (JP) 2024-168152

(51) Int. Cl. H01F 1/44; F16D 57/00

(52) U.S. Cl. CPC H01F 1/447; H01F 1/442; F16D 57/002

(57) ABSTRACT

A magnetorheological fluid includes: a metal magnetic particle having a surface modified with an ionic liquid modifying site having a first cationic group and a first anionic group; and an ionic liquid dispersion medium having a second cationic group and a second anionic group, in which the first cationic group and the second cationic group are same kind of cation and are selected from the group including a quaternary ammonium ion, an imidazolium ion, a pyridinium ion, and a phosphonium ion, and the first anionic group and the second anionic group are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

The present application is based on, and claims priority from JP Application Serial Number 2024-168152, filed Sep. 27, 2024, the disclosure of which is hereby incorporated by reference herein in its entirety.

### BACKGROUND

### 1. Technical Field

The present disclosure relates to a magnetorheological fluid and a braking device.

### 2. Related Art

The magnetorheological fluid (an MR fluid) is a fluid obtained by dispersing magnetic particles in a dispersion medium such as mineral oil or silicone oil. When a magnetic field is applied to the magnetorheological fluid, metal magnetic particles are magnetized and aligned in a magnetic field direction, thereby forming a chain cluster. Accordingly, the viscosity of the magnetorheological fluid increases, and the yield stress increases.

The use of such a magnetorheological fluid in various fields such as a control device such as a damper and a braking device such as a brake and a clutch has been studied.

In these applications, a range from minus several tens ° C. to several hundred ° C. is assumed as a temperature range in which the magnetorheological fluid is used. Therefore, the magnetorheological fluid is required to maintain physical properties not only at room temperature but also at low and high temperatures.

For example, JP-T-2010-504635 discloses that it is assumed that a magnetorheological fluid is used at a high temperature of 200° C., and an ionic liquid is used as a dispersion medium as a solution to prevent evaporation of the magnetorheological fluid.

JP-T-2010-504635 is an example of the related art.

From a viewpoint of further expanding the use range of the magnetorheological fluid, it is required to prevent aggregation and sedimentation of the magnetic particles and to exhibit high excitation stress while ensuring high reliability even when used at low and high temperatures.

### SUMMARY

A magnetorheological fluid according to an application example of the present disclosure includes:
a metal magnetic particle having a surface modified with an ionic liquid modifying site having a first cationic group and a first anionic group; and
an ionic liquid dispersion medium having a second cationic group and a second anionic group, in which
the first cationic group and the second cationic group are same type of cation and are selected from the group including a quaternary ammonium ion, an imidazolium ion, a pyridinium ion, and a phosphonium ion, and
the first anionic group and the second anionic group are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

A braking device according to an application example of the present disclosure includes:
a fixed portion;
a movable portion movable with respect to the fixed portion;
the magnetorheological fluid held between the fixed portion and the movable portion; and
a magnetic field generation unit configured to apply a magnetic field to the magnetorheological fluid.

### BRIEF DESCRIPTION OF THE DRAWINGS

FIG. 1 is a schematic diagram illustrating a magnetorheological fluid according to an embodiment.

FIG. 2 is a longitudinal cross-sectional view illustrating a braking device according to the embodiment.

FIG. 3 illustrates Table 1 indicating preparation conditions and evaluation results of the magnetorheological fluid.

FIG. 4 illustrates Table 2 indicating preparation conditions and evaluation results of the magnetorheological fluid.

FIG. 5 illustrates Table 3 indicating preparation conditions and evaluation results of the magnetorheological fluid.

FIG. 6 illustrates Table 4 indicating preparation conditions and evaluation results of the magnetorheological fluid.

FIG. 7 illustrates Table 5 indicating preparation conditions and evaluation results of the magnetorheological fluid.

FIG. 8 illustrates Table 6 indicating preparation conditions and evaluation results of the magnetorheological fluid.

### DESCRIPTION OF EMBODIMENTS

Hereinafter, a magnetorheological fluid and a braking device according to the present disclosure will be described in detail based on an embodiment illustrated in the accompanying drawings.

### 1. Magnetorheological Fluid

First, a magnetorheological fluid according to an embodiment will be described.

The magnetorheological fluid is a fluid that behaves like a liquid when a magnetic field is not applied and like a semi-solid when a magnetic field is applied. The stress of the magnetorheological fluid can be controlled by utilizing such a change in viscosity. Therefore, the magnetorheological fluid can be used in various devices that exhibit various functions by utilizing a change in stress.

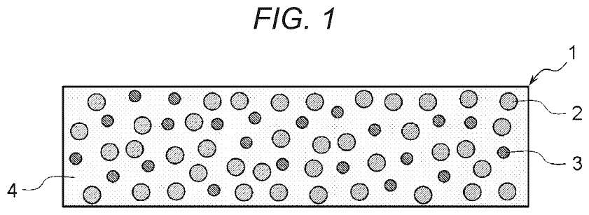

FIG. 1 is a schematic diagram illustrating a magnetorheological fluid 1 according to the embodiment. The magnetorheological fluid 1 illustrated in FIG. 1 includes metal magnetic particles 2, non-magnetic particles 3, and an ionic liquid dispersion medium 4. The metal magnetic particles 2 and the non-magnetic particles 3 are dispersoids dispersed in the ionic liquid dispersion medium 4. The non-magnetic particles 3 are provided as necessary and may be omitted.

A surface of each metal magnetic particle 2 is modified with an ionic liquid modifying site having a first cationic group and a first anionic group.

The ionic liquid dispersion medium 4 includes a second cationic group and a second anionic group.

The first cationic group included in the metal magnetic particle 2 and the second cationic group included in the ionic liquid dispersion medium 4 are the same kind of cation, and are selected from the group including a quaternary ammonium ion, an imidazolium ion, a pyridinium ion, and a phosphonium ion.

The first anionic group provided in the metal magnetic particle 2 and the second anionic group provided in the ionic liquid dispersion medium 4 are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

According to such a configuration, satisfactory affinity between the metal magnetic particles 2 and the ionic liquid dispersion medium 4 can be maintained even at low and high temperatures. That is, in the magnetorheological fluid 1 in which the metal magnetic particles 2 modified with the ionic liquid modifying sites are dispersed in the ionic liquid dispersion medium 4, sedimentation, uneven distribution, and the like of the metal magnetic particles 2 can be prevented even in a severe environment. As a result, the magnetorheological fluid 1 that maintains a satisfactory dispersed state of the dispersoids and exhibits high excitation stress regardless of the environment can be achieved.

### 1.1 Metal Magnetic Particles

The metal magnetic particle 2 includes a particle body made of a metal-based magnetic material and a surface modification film provided on a surface of the particle body.

Examples of the metal-based magnetic material include Fe-based metal materials, Ni-based metal materials, and Co-based metal materials, and one or a composite material of two or more types of these materials is used. A composite material of the metal-based magnetic material and an oxide-based magnetic material may be used. Among these materials, a Fe-based metal material is preferably used as the metal-based magnetic material from the viewpoint of high saturation magnetization.

The Fe-based metal material is a metal material containing Fe as a main component. The main component means that a content of Fe in the Fe-based metal material is 50% or more in terms of atomic ratio. Such a Fe-based metal material has saturation magnetization, toughness, and strength higher than those of ferrite. Therefore, the Fe-based metal material is useful as the metal-based magnetic material.

In addition to Fe, the Fe-based metal material may contain an element that exhibits ferromagnetic properties alone, such as Ni or Co, and may contain at least one selected from the group including Cr, Nb, Cu, Al, Mn, Mo, Si, Sn, B, C, P, Ti, and Zr according to target properties. The Fe-based metal material may contain inevitable impurities as long as the effects of the embodiment are not impaired. The inevitable impurities are impurities unintentionally mixed in raw materials or during production. Examples of the inevitable impurities include all elements other than the above-described elements, and in particular, are O, N, S, Na, Mg, and K.

Such a Fe-based metal material is not particularly limited, and examples thereof include, in addition to pure iron and carbonyl iron, Fe-based alloy materials such as a Fe—Si—Al-based alloy such as Sendust, Fe—Ni based, Fe—Co based, Fe—Ni—Co based, Fe—Si—B based, Fe—Si—Cr—B based, Fe—Si—B—C based, Fe—Si—B—Cr—C based, Fe—Si—Cr based, Fe—B based, Fe—P—C based, Fe—Co—Si—B based, Fe—Si—B—Nb based, Fe—Si—B—Nb—Cu based, Fe—Zr—B based, Fe—Cr based, and Fe—Cr—Al based alloys.

The metal-based magnetic material may be an amorphous metal material, a crystalline metal material, or a microcrystalline (nanocrystal) metal material. Among these materials, the amorphous metal material or the microcrystalline metal material is preferably used as the metal-based magnetic material. These materials contribute to sufficient lowering of the coercive force of the metal magnetic particle 2 and enhancement of the redispersibility. These materials have toughness and strength higher than, for example, those of metal oxides. Therefore, the metal magnetic particle 2 can be effectively prevented from being worn or damaged. As a result, the magnetorheological fluid 1 having a stable excitation stress can be achieved. Since the amorphous metal material and the microcrystalline metal material do not have crystal grain boundaries or are minute, corrosion originating from the crystal grain boundaries is less likely to occur. Therefore, the corrosion resistance of the metal magnetic particle 2 is particularly enhanced. The microcrystalline metal material refers to a metal material in which microcrystalline crystals (nanocrystals) having a crystal grain size of 100 nm or less are present.

Examples of the amorphous metal material include binary or multi-element Fe-based amorphous alloys such as Fe—Si—B based, Fe—Si—Cr—B based, Fe—Si—B—C based, Fe—Si—B—Cr—C based, Fe—Si—Cr based, Fe—B based, Fe—B—C based, Fe—P—C based, Fe—Co—Si—B based, Fe—Si—B—Nb based, and Fe—Zr—B based alloys, a Ni-based amorphous alloy such as Ni—Si—B based and Ni—P—B based alloys, and a Co-based amorphous alloy such as a Co—Si—B based alloy.

Examples of the microcrystalline metal material include Fe-based nanocrystal alloys such as Fe—Si—B—Nb—Cu based, Fe—Zr—B based, Fe—Hf—B based, Fe—Nb—B based, Fe—Zr—B—Co based, Fe—Hf—B—Co based, Fe—Nb—B—Co based, and Fe—Si—B—P—Cu based alloys.

The metal magnetic particle 2 may be a particle produced by any method. Examples of the production method include various atomization methods such as a water atomization method, a gas atomization method, and a rotating water flow atomization method, a pulverization method, and a carbonyl method. Among these methods, the atomization method can produce main bodies whose particle shapes are closer to perfect spheres. Such particles are less likely to aggregate.

The metal magnetic particle 2 may include an oxide film provided between the particle body and the surface modification film. The oxide film enhances adhesion of the surface modification film to the particle body. The oxide film can protect the particle body, prevent aggregation, and improve moisture resistance and rust resistance of the particle body. The oxide film preferably covers the entire surface of the particle body, but may be provided only on a part of the surface.

Examples of materials forming the oxide film include a silicon oxide, an aluminum oxide, a titanium oxide, a vanadium oxide, a niobium oxide, a chromium oxide, a manganese oxide, a tin oxide, and a zinc oxide, and one or a mixture or a composite of two or more of these materials may be used.

Among these materials, the silicon oxide is preferably used. The silicon oxide is an oxide represented by a composition formula SiOₓ (0<x≤2), and is preferably SiO₂.

The surface modification film has the ionic liquid modifying site having the first cationic group and the first anionic group. The ionic liquid modifying site is bonded to a base via, for example, a binding site derived from a coupling agent, a surfactant, or a polymer polymerized membrane. The surface modification film preferably covers the entire oxide film or the entire surface of the particle body, but may be provided only on a part of the surface. The first cationic group and the first anionic group will be described in detail later.

As the binding site, a compound derived from the coupling agent is preferably used. By using the coupling agent, an ionic liquid structure can be highly densely and stably introduced to a surface of the oxide film or the surface of the particle body. Accordingly, even in a severe environment, aggregation of the metal magnetic particles 2 can be prevented, and dispersibility of the metal magnetic particles 2 in the ionic liquid dispersion medium 4 can be further enhanced. Accordingly, the metal magnetic particle 2 which is excellent in followability to a change in magnetic field and can be uniformly dispersed even at a high concentration in the ionic liquid dispersion medium 4 can be achieved.

The surface modification film also contributes to enhancement of moisture resistance, rust resistance, and the like of the metal magnetic particle 2. Deterioration caused by moisture absorption or rust generation of the metal magnetic particle 2 can be prevented by enhancing the moisture resistance and the rust resistance.

An average particle diameter of the metal magnetic particles 2 is preferably 0.5 μm or more and 15 μm or less, more preferably 2 μm or more and 12 μm or less, and further preferably 4 μm or more and 10 μm or less. When the average particle diameter of the metal magnetic particle 2 is within the above ranges, the magnetic field responsiveness of the metal magnetic particle 2 can be sufficiently increased. In addition, sedimentation of the metal magnetic particle 2 can be prevented. Accordingly, the excitation stress of the magnetorheological fluid 1 can be increased. When the average particle diameter of the metal magnetic particle 2 is below the above lower limit value, the magnetic field responsiveness of the metal magnetic particles 2 decreases, and therefore the excitation stress of the magnetorheological fluid 1 may decrease. In contrast, when the average particle diameter of the metal magnetic particle 2 exceeds the above upper limit value, the metal magnetic particle 2 may be more likely to settle. When the metal magnetic particle 2 settles, a necessary excitation stress may not be obtained.

The average particle diameter of the metal magnetic particle 2 can be obtained from a volume-based particle size distribution with a laser diffraction and dispersion method. Specifically, a median diameter in the particle size distribution is taken as the average particle diameter. Examples of a device that measures the particle size distribution with the laser diffraction and dispersion method include MT3300 series manufactured by Microtrac, Inc.

A content of the metal magnetic particles 2 in the magnetorheological fluid 1 is preferably 40 mass % or more and 95 mass % or less, more preferably 50 mass % or more and 90 mass % or less, and further preferably 60 mass % or more and 85 mass % or less. Accordingly, the viscosity of the magnetorheological fluid 1 can be optimized. The excitation stress in the magnetorheological fluid 1 can be sufficiently increased.

A particle shape of the metal magnetic particle 2 is not particularly limited, and may be a perfect sphere, an oval sphere, a polyhedron, or other shapes. Examples of other shapes include a needle shape, a fiber shape, a plate shape, a scale shape, and a hollow shape.

### 1.2. Non-Magnetic Particles

The non-magnetic particle 3 is a particle made of a non-magnetic material and having an average particle diameter less than that of the metal magnetic particle 2. Such a non-magnetic particle 3 is dispersed in the ionic liquid dispersion medium 4 by random Brownian motion. The non-magnetic particle 3 undergoing Brownian motion generates a diffusion force larger than a sedimentation force caused by gravity, floats, and also contributes to prevention of the sedimentation of the metal magnetic particle 2. Therefore, by using the non-magnetic particle 3, a satisfactory dispersed state of the metal magnetic particles 2 can be maintained. An average particle diameter of the non-magnetic particle is preferably about 0.1% or more and about 1% or less of the average particle diameter of the metal magnetic particle 2.

An average particle diameter of the non-magnetic particle 3 is preferably 10 nm or more and 800 nm or less, more preferably 12 nm or more and 600 nm or less, and further preferably 14 nm or more and 550 nm or less. When the average particle diameter of the non-magnetic particle 3 is within the above ranges, a lifting effect by Brownian motion of the non-magnetic particle 3 can be sufficiently obtained. When the average particle diameter of the non-magnetic particle 3 is below the above lower limit value, a surface area of the non-magnetic particle 3 is reduced, and a sufficient lifting effect may not be obtained even when the non-magnetic particle 3 performs Brownian motion. In contrast, when the average particle diameter of the non-magnetic particle 3 exceeds the above upper limit value, Brownian motion of the non-magnetic particle 3 decreases, and the lifting effect may be reduced.

The average particle diameter of the non-magnetic particle 3 can be obtained from a volume-based particle size distribution with a laser diffraction and dispersion method. Specifically, a median diameter in the particle size distribution is taken as the average particle diameter. Examples of a device that measures the particle size distribution with the laser diffraction and dispersion method include MT3300 series manufactured by Microtrac, Inc.

Examples of materials forming the non-magnetic particle 3 include a non-magnetic inorganic material, a thermoplastic resin, and a thermosetting resin.

Examples of the non-magnetic inorganic material include non-magnetic metals such as gold, silver, copper, palladium, and platinum, ceramics such as a metal oxide, a metal nitride, a metal carbide, a metal carbonate, a metal halide, a metal phosphate, and a metal sulfate, and carbon-based materials such as carbon black and graphite. By using such an inorganic material, the durability of the non-magnetic particle 3 can be easily enhanced.

Examples of the metal oxide include alumina, silica, titanium oxide, zinc oxide, calcium oxide, magnesium oxide, tin dioxide, silicon dioxide, non-magnetic chromium oxide, cerium oxide, and non-magnetic iron oxide. Examples of the metal nitride include boron nitride and silicon nitride. Examples of the metal carbide include silicon carbide, molybdenum carbide, boron carbide, tungsten carbide, and titanium carbide. Examples of the metal carbonate include magnesium carbonate and calcium carbonate. Examples of the metal halide include calcium fluoride, sodium fluoride, potassium fluoride, cesium fluoride, and lithium chloride. Examples of the metal sulfate include barium sulfate and calcium sulfate.

Examples of the thermoplastic resin include an acrylic resin, a polystyrene resin, a vinyl resin such as a polyvinyl acetate resin and a polyvinyl chloride resin, a polyester resin, an ABS resin, and an AS resin.

Examples of the thermosetting resin include a phenol resin, an epoxy resin, a melamine resin, a urea resin, an unsaturated polyester resin, and an alkyd resin.

A content of the non-magnetic particles 3 in the magnetorheological fluid 1 is preferably 0.01 mass % or more and 5 mass % or less, more preferably 0.1 mass % or more and 3 mass % or less, and further preferably 0.5 mass % or more and 2 mass % or less. Accordingly, the sedimentation of the metal magnetic particle 2 can be satisfactorily prevented by the lifting effect while satisfactorily maintaining the dispersed state of the non-magnetic particles 3. When the content of the non-magnetic particles 3 is below the above lower limit value, the lifting effect may be reduced. In contrast, when the content of the non-magnetic particles 3 exceeds the above upper limit value, aggregation of the non-magnetic particles 3 is likely to occur, and the dispersed state of the non-magnetic particles 3 may be poor.

Various additives may be added to the magnetorheological fluid 1. Examples of the additive include a detergent, a dispersant, an antioxidant, an anti-wear agent, an extreme pressure agent, a friction modifier, a surfactant, a thixotropy-imparting agent (thickener), and a viscosity-reducing agent, and one or a mixture of two or more of these additives is used.

Examples of the dispersant include oleates, naphthenates, sulfonates, phosphate esters, stearic acid, stearates, glycerol monooleate, sorbitan sesquioleate, lauric acid, fatty acids, and fatty alcohols.

Examples of the anti-wear agent include organic molybdenum compounds such as molybdenum dialkyldithiocarbamates and molybdenum dialkyldithiophosphates, and organic zinc compounds such as zinc dialkyldithiocarbamates and zinc dialkyldithiophosphates.

A total content of the additive is preferably 10 mass % or less, more preferably 8 mass % or less, and further preferably 6 mass % or less of the entire magnetorheological fluid 1. Accordingly, it is possible to prevent the respective functions of the metal magnetic particles 2 and the non-magnetic particles 3 from being hindered by the additive.

### 1.3. Ionic Liquid Dispersion Medium

The ionic liquid dispersion medium 4 has the second cationic group and the second anionic group. The second cationic group and the second anionic group will be described in detail later.

A content of the ionic liquid dispersion medium 4 in the magnetorheological fluid 1 is preferably 5 mass % or more and 60 mass % or less, more preferably 10 mass % or more and 50 mass % or less, and further preferably 10 mass % or more and 30 mass % or less. Accordingly, the dispersed state of the dispersoids can be satisfactorily maintained. In addition, the viscosity of the magnetorheological fluid 1 can be optimized.

The magnetorheological fluid 1 may contain a liquid component (a dispersion medium) other than the ionic liquid dispersion medium 4 or may contain an additive in a range not impairing the effect achieved by the ionic liquid dispersion medium 4. Examples of such an additive include a thixotropic agent, a surfactant, a plastic medium, and a water-in-oil emulsion.

### 1.4. Cationic Group and Anionic Group

As described above, the ionic liquid modifying site provided in the metal magnetic particle 2 has the first cationic group and the first anionic group. The ionic liquid dispersion medium 4 has the second cationic group and the second anionic group.

The first cationic group and the second cationic group are the same kind of cation, and are selected from the group including a quaternary ammonium ion, an imidazolium ion, a pyridinium ion, and a phosphonium ion.

The first anionic group and the second anionic group are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

Both of the above specific cations and the above specific anions are bulky ions and are ions having a relatively high ionic strength. By using ions having a high ionic strength as the first cationic group and the first anionic group, the ionic liquid modifying site can maintain satisfactory affinity for the ionic liquid dispersion medium 4 even in a severe environment. By using ions having a high ionic strength as the second cationic group and the second anionic group, the ionic liquid dispersion medium 4, which is still a liquid even at a low temperature such as 0° C. or lower and is less likely to evaporate even at a high temperature such as 250° C. or higher, is obtained. Accordingly, the ionic liquid dispersion medium 4 can be present without causing coagulation or evaporation of the ionic liquid dispersion medium 4 even at a low temperature or a high temperature, and can maintain satisfactory affinity for the ionic liquid modifying site even in a severe environment.

By selecting the same type of cation as the first cationic group and the second cationic group, the metal magnetic particles 2 having the ionic liquid modifying site can maintain a satisfactory dispersed state in the ionic liquid dispersion medium 4. As a result, the magnetorheological fluid 1 exhibiting high excitation stress can be achieved regardless of the environment.

The same type of cations refers to cations having the same main skeleton. That is, in the present specification, two cations that have the same main skeleton but different molecular structures in other respects, as a specific example, two cations in which the numbers of carbon atoms in the alkyl groups bonded to the main skeleton are different, are considered to be the same type of cation.

Among alkyl groups bonded to the main skeleton of the first cationic group, an alkyl group having the largest number of carbon atoms is defined as a first long-chain alkyl group. Among alkyl groups bonded to the main skeleton of the second cationic group, an alkyl group having the largest number of carbon atoms is defined as a second long-chain alkyl group. At this time, the number of carbon atoms in the first long-chain alkyl group and the number of carbon atoms in the second long-chain alkyl group are preferably the same. That is, it is preferable that the first cationic group and the second cationic group are the same kind of cation and the number of carbon atoms in each of the first long-chain alkyl group and the second long-chain alkyl group is the same. Accordingly, the dispersibility of the metal magnetic particles 2 in the ionic liquid dispersion medium 4 is particularly enhanced. As a result, the magnetorheological fluid 1 exhibiting even higher excitation stress can be achieved even under a severe environment.

### 1.4.1. Cationic Group

The first cationic group and the second cationic group used in the embodiment are each selected from the group including a quaternary ammonium ion, an imidazolium ion, a pyridinium ion, and a phosphonium ion.

### 1.4.1.1 Quaternary Ammonium Ion

Examples of the quaternary ammonium ion include a cation represented by the following formula (A). A main skeleton of the cation is a nitrogen atom.

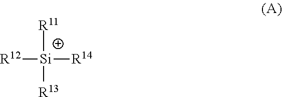

In the formula (A), R¹¹ to R¹⁴ each independently represent a linear or branched alkyl group having 1 or more and 20 or less carbon atoms. R¹¹ to R¹⁴ may be bonded to each other to form a ring.

When R¹¹ to R¹⁴ are each a linear or branched alkyl group, the quaternary ammonium ion is also particularly referred to as an aliphatic quaternary ammonium ion. When R¹¹ to R¹⁴ are bonded to each other to form a ring, the quaternary ammonium ion is particularly referred to as an alicyclic quaternary ammonium ion.

Examples of the linear alkyl group of R¹¹ to R¹⁴ include a linear alkyl group having 1 or more and 20 or less carbon atoms. Specific examples thereof include a methyl group, an ethyl group, a propyl group, a butyl group, a pentyl group, a hexyl group, a heptyl group, an octyl group, a nonyl group, a decanyl group, an undecyl group, a dodecyl group, a tridecyl group, a tetradecyl group, a pentadecyl group, a hexadecyl group, a heptadecyl group, an octadecyl group, a nonadecyl group, and an icosyl group.

Examples of the branched alkyl group of R¹¹ to R¹⁴ include a branched alkyl group having 3 or more and 20 or less carbon atoms. Specific examples thereof include a 1-methylethyl group, a 1-methylpropyl group, a 2-methylpropyl group, a 1-methylbutyl group, a 2-methylbutyl group, a 3-methylbutyl group, a 1-ethylbutyl group, a 2-ethylbutyl group, a 1-methylpentyl group, a 2-methylpentyl group, a 3-methylpentyl group, and a 4-methylpentyl group.

When R¹¹ to R¹⁴ are bonded to each other to form a ring, examples of the formed ring include a cyclopropyl group, a cyclobutyl group, a cyclopentyl group, a cyclohexyl group, a cycloheptyl group, a cyclooctyl group, a cyclodecyl group, and a cyclododecyl group.

Specific examples of the quaternary ammonium ion include tetraethylammonium, tetramethylammonium, tetrapropyl ammonium, tetrabutyl ammonium, and tetrapentyl ammonium.

As the quaternary ammonium ion, a cation represented by the following (A)-1 or (A)-2 is more preferable.

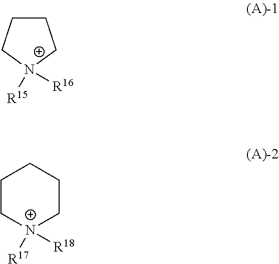

In the formula (A)-1, R¹⁵ represents an alkyl group having 1 or more and 2 or less carbon atoms, and R¹⁶ represents an alkyl group having 1 or more and 8 or less carbon atoms. In the formula (A)-2, R¹⁷ represents an alkyl group having 1 or more and 2 or less carbon atoms, and R¹⁸ represents an alkyl group having 1 or more and 8 or less carbon atoms.

As the quaternary ammonium ion, a cation represented by the following (A)-3 or (A)-4 is further preferable. Accordingly, the magnetorheological fluid 1 capable of maintaining a satisfactory dispersed state of the metal magnetic particles 2 even at a high temperature of 300° C. or higher can be achieved. In this case, the tetrafluoroborate ion is particularly preferably used as the anionic group.

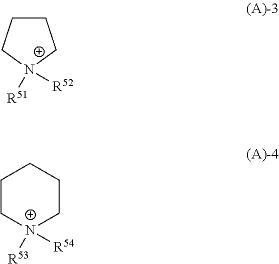

In the formula (A)-3, R⁵¹ represents an alkyl group having 2 carbon atoms, and R⁵² represents an alkyl group having 1 or more and 2 or less carbon atoms. In the formula (A)-4, R⁵³ represents an alkyl group having 2 carbon atoms, and R⁵⁴ represents an alkyl group having 1 or more and 2 or less carbon atoms.

### 1.4.1.2. Imidazolium Ion

Examples of the imidazolium ion include a cation represented by the following formula (B). The main skeleton of the cation is a 5-membered ring structure composed of a carbon atom and a nitrogen atom.

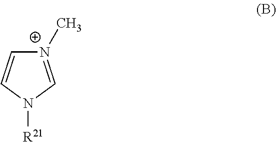

In the formula (B), R²¹ and R²² each independently represent a linear or branched alkyl group having 1 or more and 20 or less carbon atoms.

The description of the alkyl groups of R²¹ and R²² in the formula (B) is the same as the description of the alkyl groups of R¹¹ to R¹⁴ in the formula (A).

R²¹ and R²² are each preferably an alkyl group having 1 or more and 10 or less carbon atoms, and more preferably an alkyl group having 1 or more and 8 or less carbon atoms.

Examples of R²¹ and R²² include an n-butyl group, a sec-butyl group, an isobutyl group, a tert-butyl group, a pentyl group, a hexyl group, a heptyl group, and an octyl group.

As the imidazolium ion, a cation represented by the following formula (B)-1 is more preferable. Accordingly, the magnetorheological fluid 1 capable of maintaining a satisfactory dispersed state of the metal magnetic particles 2 even at a high temperature of 300° C. or higher can be achieved. In this case, the tetrafluoroborate ion is particularly preferably used as the anionic group.

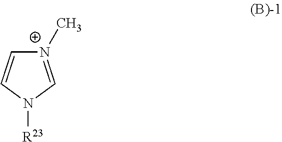

In the formula (B)-1, R²³ represents an alkyl group having 2 carbon atoms, and R²⁴ represents an alkyl group having 1 or more and 2 or less carbon atoms.

### 1.4.1.3. Pyridinium Ion

Examples of the pyridinium ion include a cation represented by the following formula (C). The main skeleton of the cation is a 6-membered ring structure formed by a carbon atom and a nitrogen atom.

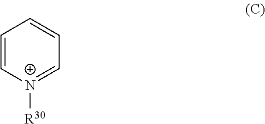

In the formula (C), R³⁰ represents a linear or branched alkyl group having 1 or more and 20 or less carbon atoms.

The description of the alkyl group of R³⁰ in the formula (C) is the same as the description of the alkyl groups of R¹¹ to R¹⁴ in the formula (A).

R³⁰ is preferably an alkyl group having 1 or more and 10 or less carbon atoms, and more preferably an alkyl group having 1 or more and 8 or less carbon atoms.

Examples of R³⁰ include an n-butyl group, a sec-butyl group, an isobutyl group, a tert-butyl group, a pentyl group, and a hexyl group.

As the pyridinium ion, a cation represented by the following formula (C)-1 is more preferable. Accordingly, the magnetorheological fluid 1 capable of maintaining a satisfactory dispersed state of the metal magnetic particles 2 even at a high temperature of 300° C. or higher can be achieved. In this case, the tetrafluoroborate ion is particularly preferably used as the anionic group.

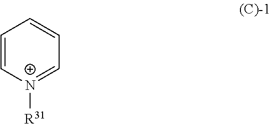

In the formula (C)-1, R³¹ represents an alkyl group having 1 or more and 2 or less carbon atoms.

### 1.4.1.4. Phosphonium Ion

Examples of the phosphonium ion include a cation represented by the following formula (D). The main skeleton of the cation is a phosphorus atom.

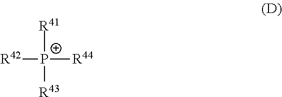

In the formula (D), R⁴¹ to R⁴⁴ each independently represent a linear or branched alkyl group having 1 or more and 20 or less carbon atoms. R⁴¹ to R⁴⁴ may be bonded to each other to form a ring.

The description of the alkyl groups of R⁴¹ to R⁴⁴ in the formula (D) is the same as the description of the alkyl groups of R¹¹ to R¹⁴ in the formula (A).

R⁴¹ to R⁴⁴ are each preferably an alkyl group having 2 or more and 18 or less carbon atoms, and more preferably an alkyl group having 4 or more and 16 or less carbon atoms.

Specific examples of the phosphonium ion include tetrabutylphosphonium, tetrapropylphosphonium, tetraethylphosphonium, tetramethylphosphonium, and hexadecyltributylphosphonium.

### 1.4.2. Anionic Group

The first anionic group and the second anionic group used in the embodiment are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

All of such anions are bulky ions. Therefore, by using the enumerated anions as the first anionic group and the second anionic group, the magnetorheological fluid 1 capable of maintaining a satisfactory dispersed state even at a low temperature or a high temperature can be achieved.

The first anionic group and the second anionic group are each preferably selected from the group including a tetrafluoroborate ion, a hexafluorophosphate ion, a trispentafluoroethyl trifluorophosphate ion, and a bis(trifluoromethanesulfonyl)amide ion. Accordingly, the above effect becomes more significant.

The first anionic group and the second anionic group are more preferably tetrafluoroborate ions. Accordingly, the magnetorheological fluid 1 capable of maintaining a satisfactory dispersed state of the metal magnetic particles 2 even after being heated at a high temperature of 300° C. can be achieved.

Different anions may be selected for the first anionic group and the second anionic group, but anions of the same type are preferably selected. Accordingly, the metal magnetic particles 2 each having the ionic liquid modifying site can maintain a more satisfactory dispersed state in the ionic liquid dispersion medium 4. As a result, the magnetorheological fluid 1 exhibiting high excitation stress can be achieved regardless of the environment.

### 1.4.3. Ionic Strength

An ionic strength of the ionic liquid modifying site having the first cationic group and the first anionic group is defined as μ1. An ionic strength of the ionic liquid dispersion medium 4 having the second cationic group and the second anionic group is defined as μ2. In this case, an ionic strength of the entire magnetorheological fluid 1 can be evaluated using an average value μA of the ionic strength μ1 and the ionic strength μ2. The average value μA of the ionic strength is preferably 5.00 mol/L or more and 14.00 mol/L or less, and more preferably 10.00 mol/L or more and 13.00 mol/L or less. In this case, ionic liquids having a relatively high ionic strength interact with each other. Therefore, even at a high temperature, the metal magnetic particles 2 can maintain a more satisfactory dispersed state in the ionic liquid dispersion medium 4.

When the average value μA is below the above lower limit value, ionic bonds between molecules in the ionic liquid may be weakened. In this case, the dispersibility of the metal magnetic particles 2 at a high temperature may decrease. In contrast, when the average value μA exceeds the above upper limit value, it may become difficult to select ions.

The ionic strength μ1 of the ionic liquid modifying site is preferably 5.00 mol/L or more and 14.00 mol/L or less, and more preferably 10.00 mol/L or more and 13.00 mol/L or less. In this case, the ionic bond of the ionic liquid modifying site is sufficiently strong.

The ionic strength μ2 of the ionic liquid dispersion medium 4 is preferably 5.00 mol/L or more and 14.00 mol/L or less, and more preferably 10.00 mol/L or more and 13.00 mol/L or less. In this case, the ionic bond of the ionic liquid dispersion medium 4 is sufficiently strong.

The ionic strength is obtained by adding up the product of the molar concentration of ions and the square of the valence of the ions for all ion types and multiplying the sum by 1/2.

### 1.3. Physical Properties of Magnetorheological Fluid

The excitation stress of the magnetorheological fluid 1 can be evaluated as a yield stress when a magnetic field having a magnetic flux density of 1.0 T is applied. The excitation stress is preferably 10 kPa or more, and more preferably 15 kPa or more. Accordingly, the magnetorheological fluid 1 exhibiting sufficient excitation stress is obtained. Such a magnetorheological fluid 1 is useful in various applications.

The excitation stress of the magnetorheological fluid 1 is measured as follows.

First, a magnetic field having a magnetic flux density of 1.0 T is applied to the magnetorheological fluid 1 at a predetermined temperature. Next, in this state, a shear rate of 333/s is applied to measure a shear stress. To measure the shear stress, for example, a rheometer MCR102 manufactured by Anton Paar can be used. Then, the measured shear stress is used as the yield stress.

The excitation stress is preferably within the above range regardless of the temperature. For example, the excitation stress of the magnetorheological fluid 1 after being left in an environment of a temperature of 300° C. for 1 hour is also preferably 10 kPa or more, and more preferably 15 kPa or more. Accordingly, the magnetorheological fluid 1 exhibiting sufficient excitation stress even at a high temperature is obtained. Such a magnetorheological fluid 1 can maintain the same characteristics as at a room temperature even in a severe temperature environment.

A boiling point of the magnetorheological fluid 1 is preferably 250° C. or higher, more preferably 300° C. or higher, and further preferably 350° C. or higher. Accordingly, the magnetorheological fluid 1 having sufficient heat resistance is obtained.

The boiling point of the magnetorheological fluid 1 is measured as follows.

First, 2 mL of the magnetorheological fluid 1 is heated by a hot plate. Next, the temperature of the magnetorheological fluid 1 when white smoke is generated is measured, and the measurement value is taken as the boiling point.

A freezing point of the magnetorheological fluid 1 is preferably 0° C. or lower, more preferably −10° C. or lower, and further more preferably −20° C. or lower. Accordingly, the magnetorheological fluid 1 having sufficient cold resistance is obtained.

The freezing point of the magnetorheological fluid 1 is measured as follows.

First, 2 mL of the magnetorheological fluid 1 is cooled by a refrigerator. Next, the temperature at which the magnetorheological fluid 1 is solidified is measured, and the measurement value is taken as the freezing point.

### 1.4. Application Examples of Magnetorheological Fluid

Examples of applications of the magnetorheological fluid 1 include various apparatuses or devices utilizing a difference in excitation stress that occurs when the application of a magnetic field is switched. Examples of such an apparatus or a device include a vibration control device such as a linear damper, a rotary damper, or a shock absorber, a braking device such as a brake, a power transmission device such as a clutch, a muscle part or an end effector of a robot, a valve for controlling a liquid flow rate, a tactile presentation device, an acoustic device, a medical and welfare robot hand, a nursing hand, and personal mobility.

### 1.5. Method for Producing Magnetorheological Fluid

An example of a method for producing the magnetorheological fluid 1 will be described. In the method for producing the magnetorheological fluid 1, first, the surface modification film is formed at the surface of the particle body of the metal-based magnetic material. To form the surface modification film, for example, a coupling agent (an ionic liquid coupling agent) having the ionic liquid modifying site as a functional group is used. The ionic liquid coupling agent is a compound having the ionic liquid modifying site and a hydrolyzable group, and is preferably used to introduce the ionic liquid modifying site into the particle surface of the metal-based magnetic material or the surface of the oxide film by a hydrolysis reaction and a polycondensation reaction. Specifically, the ionic liquid coupling agent is dissolved in a solvent to prepare a solution. The obtained solution is subjected to ultrasonic treatment and hand shaking stirring. Accordingly, the ionic liquid coupling agent is reacted with the surface of the particle body. The treated particle body is recovered by magnetic separation and subjected to heat treatment. Examples of heating conditions include a heating temperature of 50° C. or higher and 150° C. or lower and a heating time of 30 minutes or more and 180 minutes or less. Accordingly, the surface modification film is formed, and the metal magnetic particles 2 are obtained.

After the surface modification film is formed, a formation state of the surface modification film can be confirmed by surface elemental analysis. For the surface elemental analysis, for example, an ESCA (X-ray photoelectron spectroscopy) is used. Then, the formation state of the surface modification film can be determined by confirming the presence or absence of a specific element (nitrogen or the like) possessed by the cation and the presence or absence of a specific element (boron, fluorine, sulfur, or the like) possessed by the anion.

Next, the metal magnetic particles 2, the non-magnetic particles 3, and the ionic liquid dispersion medium 4 are mixed and stirred. Examples of a stirring method include stirring with a spatula, a vortex mixer, a high shear mixer, and a low-frequency acoustic resonance mixer. The stirring time is appropriately set according to the stirring method and is preferably 5 minutes or more and 4 hours or less. The stirring temperature is appropriately set according to the stirring method and is preferably 15° C. or higher and 70° C. or lower.

### 2. Braking Device

Next, a braking device according to the embodiment will be described.

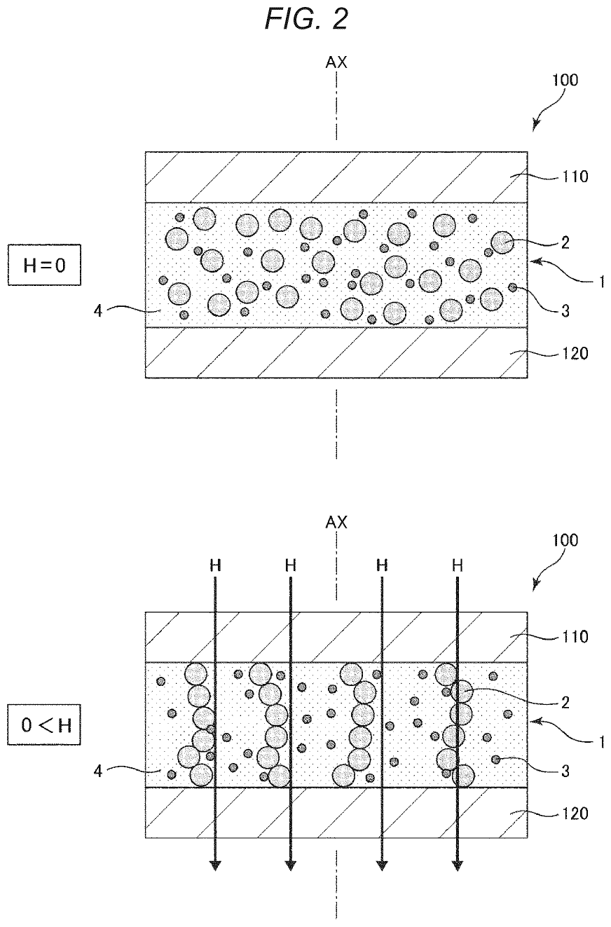

FIG. 2 is a longitudinal cross-sectional view illustrating a braking device 100 according to the embodiment.

The braking device 100 illustrated in FIG. 2 includes a fixed disk 110 (a fixed portion), a movable disk 120 (a movable portion), and the magnetorheological fluid 1. The movable disk 120 is rotatable (movable) about a rotation axis AX with respect to the fixed disk 110. The magnetorheological fluid 1 is held between the fixed disk 110 and the movable disk 120. The braking device 100 includes a magnetic field generation unit (not illustrated). The magnetic field generation unit applies a magnetic field to the magnetorheological fluid 1.

In the braking device 100, the excitation stress of the magnetorheological fluid can be changed by switching the magnetic field applied to the magnetorheological fluid 1. Accordingly, a resistance force to rotation of the movable disk 120 with respect to the fixed disk 110 can be changed. As a result, the braking device 100 uses the resistance force as a brake force to brake a vehicle or the like.

The fixed disk 110 is coupled to, for example, a vehicle body side of the automobile, and the movable disk 120 is coupled to, for example, a wheel side of the automobile.

When a magnetic field H is not applied to the magnetorheological fluid 1 (H=0), the metal magnetic particles 2 and the non-magnetic particles 3 are in the dispersed state in the magnetorheological fluid 1. In this case, the excitation stress of the magnetorheological fluid 1 is sufficiently small, and almost no brake force is generated.

When the magnetic field H is applied to the magnetorheological fluid 1 (0<H), in the magnetorheological fluid 1, the metal magnetic particles 2 form a cluster structure. In this case, the excitation stress of the magnetorheological fluid 1 increases, and the brake force is generated.

The magnetorheological fluid 1 according to the embodiment described above can achieve both high reliability and high excitation stress even when being used at a low temperature or a high temperature. Therefore, the braking device 100 according to the embodiment has high reliability without causing a decrease in brake force even in a severe environment.

The configuration of the braking device 100 is not limited to thereto. For example, the braking device of the present disclosure may include three or more disks.

### 3. Effects of Embodiment

As described above, the magnetorheological fluid 1 according to the above embodiment includes the metal magnetic particles 2 and the ionic liquid dispersion medium 4. The surface of the metal magnetic particle 2 is modified with the ionic liquid modifying site having the first cationic group and the first anionic group. The ionic liquid dispersion medium 4 has the second cationic group and the second anionic group.

The first cationic group and the second cationic group are the same kind of cation, and are selected from the group including a quaternary ammonium ion, an imidazolium ion, a pyridinium ion, and a phosphonium ion. The first anionic group and the second anionic group are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

According to such a configuration, the magnetorheological fluid 1 capable of achieving both high reliability and high excitation stress can be obtained even when being used at a low temperature or a high temperature.

In the magnetorheological fluid 1 according to the above embodiment, the first cationic group and the second cationic group are preferably cations represented by the following formulas (A)-3, (A)-4, (B)-1, and (C)-1.

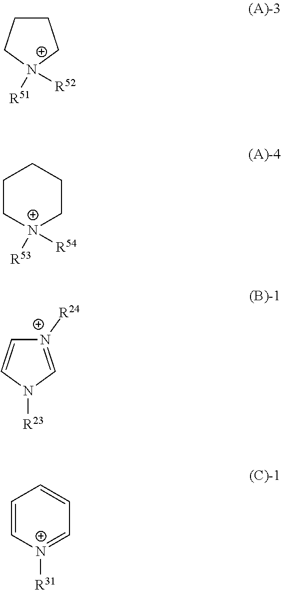

In the formula (A)-3, R⁵¹ represents an alkyl group having 2 carbon atoms, and R⁵² represents an alkyl group having 1 or more and 2 or less carbon atoms. In the formula (A)-4, R⁵³ represents an alkyl group having 2 carbon atoms, and R⁵⁴ is an alkyl group having 1 or more and 2 or less carbon atoms. In the formula (B)-1, R²³ represents an alkyl group having 2 carbon atoms, and R²⁴ is an alkyl group having 1 or more and 2 or less carbon atoms. In the formula (C)-1, R³¹ represents an alkyl group having 1 or more and 2 or less carbon atoms.

According to such a configuration, the magnetorheological fluid 1 capable of maintaining a satisfactory dispersed state of the metal magnetic particles 2 even at a high temperature of 300° C. or higher can be achieved.

In the magnetorheological fluid 1 according to the above embodiment, each of the first cationic group and the second cationic group may have an alkyl group. Among alkyl groups provided in the first cationic group, an alkyl group having the largest number of carbon atoms is defined as a first long-chain alkyl group, and among alkyl groups provided in the second cationic group, an alkyl group having the largest number of carbon atoms is defined as a second long-chain alkyl group. At this time, the number of carbon atoms in the first long-chain alkyl group and the number of carbon atoms in the second long-chain alkyl group may be the same.

According to such a configuration, the dispersibility of the metal magnetic particles 2 in the ionic liquid dispersion medium 4 is particularly enhanced. As a result, the magnetorheological fluid 1 exhibiting even higher excitation stress can be achieved even under a severe environment.

In the magnetorheological fluid 1 according to the above embodiment, the first anionic group and the second anionic group may be tetrafluoroborate ions.

According to such a configuration, the magnetorheological fluid 1 capable of maintaining a satisfactory dispersed state of the metal magnetic particles 2 even after being heated at a high temperature of 300° C. can be achieved.

In the magnetorheological fluid 1 according to the above embodiment, the average particle diameter of the metal magnetic particles 2 may be 0.5 μm or more and 15 μm or less.

According to such a configuration, the magnetic field responsiveness of the metal magnetic particles 2 can be sufficiently increased. In addition, sedimentation of the metal magnetic particle 2 can be prevented. Accordingly, the excitation stress of the magnetorheological fluid 1 can be increased.

In the magnetorheological fluid 1 according to the above embodiment, the average value μA of the ionic strength μ1 of the ionic liquid modifying site and the ionic strength μ2 of the ionic liquid dispersion medium may be 5.00 mol/L or more and 14.00 mol/L or less.

According to such a configuration, ionic liquids having a relatively high ionic strength interact with each other. Therefore, even at a high temperature, the metal magnetic particles 2 can maintain a more satisfactory dispersed state in the ionic liquid dispersion medium 4.

The magnetorheological fluid 1 according to the above embodiment may include the non-magnetic particles 3 each having an average particle diameter less than that of the metal magnetic particles 2.

According to such a configuration, the non-magnetic particle 3 performs Brownian motion to generate a diffusion force larger than a sedimentation force caused by gravity, floats, and also contributes to prevention of the sedimentation of the metal magnetic particle 2. Therefore, by using the non-magnetic particle 3, a satisfactory dispersed state of the metal magnetic particles 2 can be maintained.

In the magnetorheological fluid 1 according to the above embodiment, a material forming the non-magnetic particles 3 may be an inorganic material.

According to such a configuration, the durability of the non-magnetic particles 3 can be easily increased.

In the magnetorheological fluid 1 according to the above embodiment, the content of the non-magnetic particles 3 may be 0.01 mass % or more and 5 mass % or less.

According to such a configuration, the sedimentation of the metal magnetic particle 2 can be satisfactorily prevented by the lifting effect while satisfactorily maintaining the dispersed state of the non-magnetic particles 3.

The yield stress of the magnetorheological fluid 1 according to the above embodiment when a magnetic field of 1.0 T is applied after being left in an environment of a temperature of 300° C. for 1 hour is 15 kPa or more.

According to such a configuration, the magnetorheological fluid 1 exhibiting sufficient excitation stress even at a high temperature is obtained. Such a magnetorheological fluid 1 can maintain the same characteristics as at a room temperature even in a severe temperature environment.

In the magnetorheological fluid 1 according to the above embodiment, the first anionic group and the second anionic group may be the same kind of anion.

According to such a configuration, the metal magnetic particles 2 each having the ionic liquid modifying site can maintain a more satisfactory dispersed state in the ionic liquid dispersion medium 4. As a result, the magnetorheological fluid 1 exhibiting high excitation stress can be achieved regardless of the environment.

The braking device 100 according to the above embodiment includes the fixed disk 110 (a fixed portion), the movable disk 120 (a movable portion), the magnetorheological fluid 1 according to the above embodiment, and a magnetic field generation unit. The movable disk 120 is movable with respect to the fixed disk 110. The magnetorheological fluid 1 is held between the fixed disk 110 and the movable disk 120. The magnetic field generation unit applies a magnetic field to the magnetorheological fluid 1.

According to such a configuration, the braking device 100 having high reliability without causing a decrease in brake force even in a severe environment can be achieved.

As described above, the magnetorheological fluid and the braking device according to the present disclosure have been described based on the preferred embodiment, but the present disclosure is not limited thereto.

For example, the magnetorheological fluid and the braking device according to the present disclosure may be obtained by adding any configuration to the above embodiment. The configuration of each part of the braking device according to the above embodiment may be replaced with a configuration having the same function as described above.

### EXAMPLES

Next, specific examples of the present disclosure will be described.

### 4. Preparation of Magnetorheological Fluid

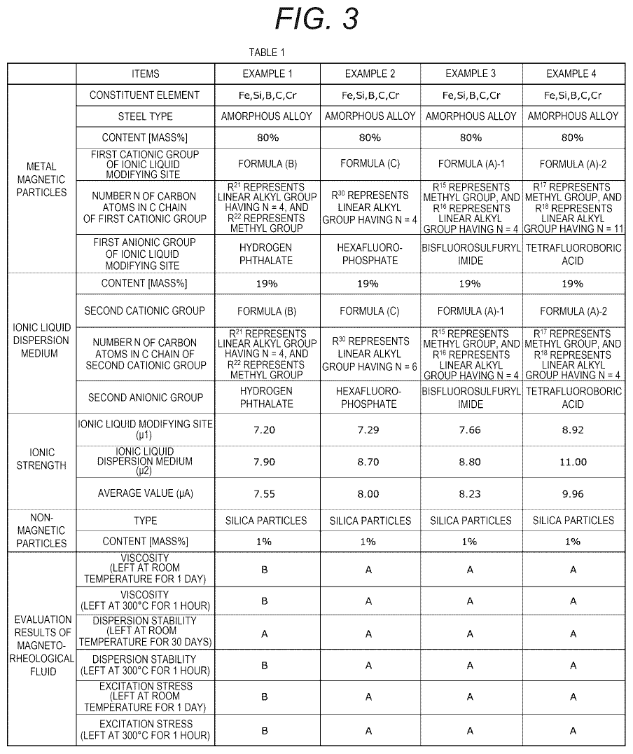

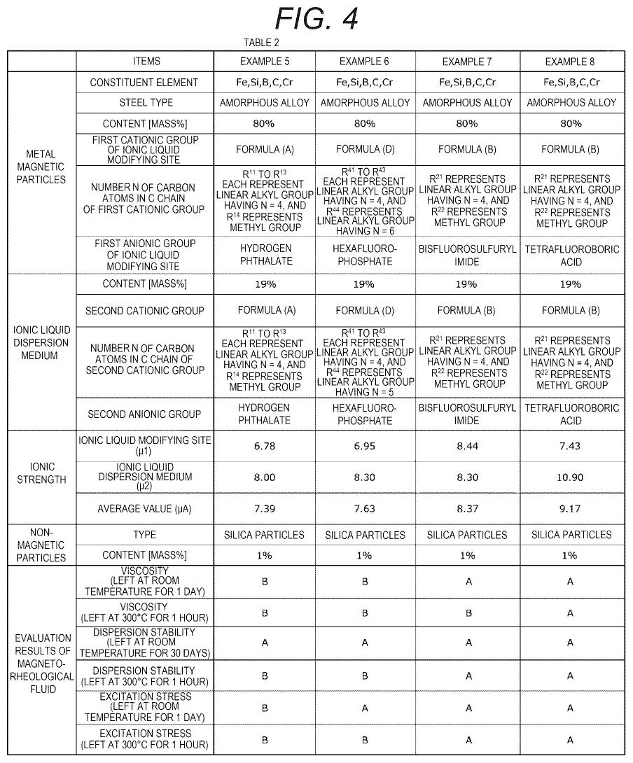

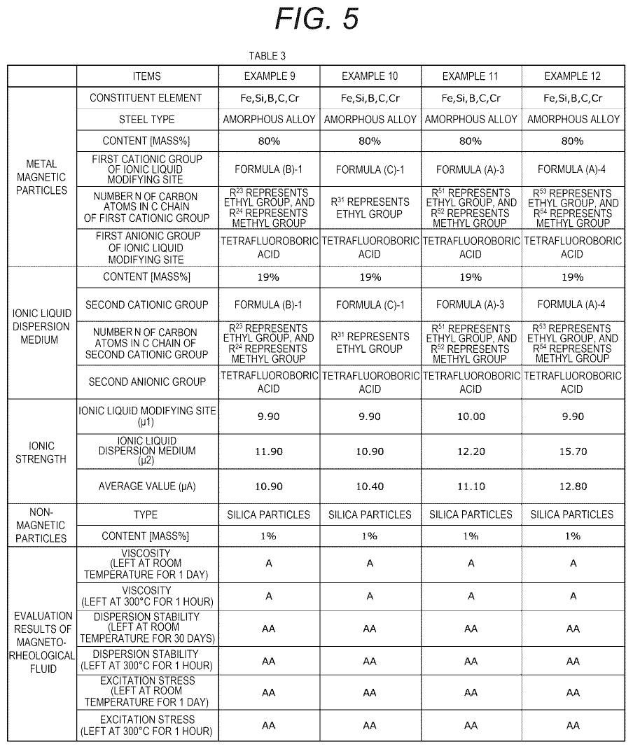

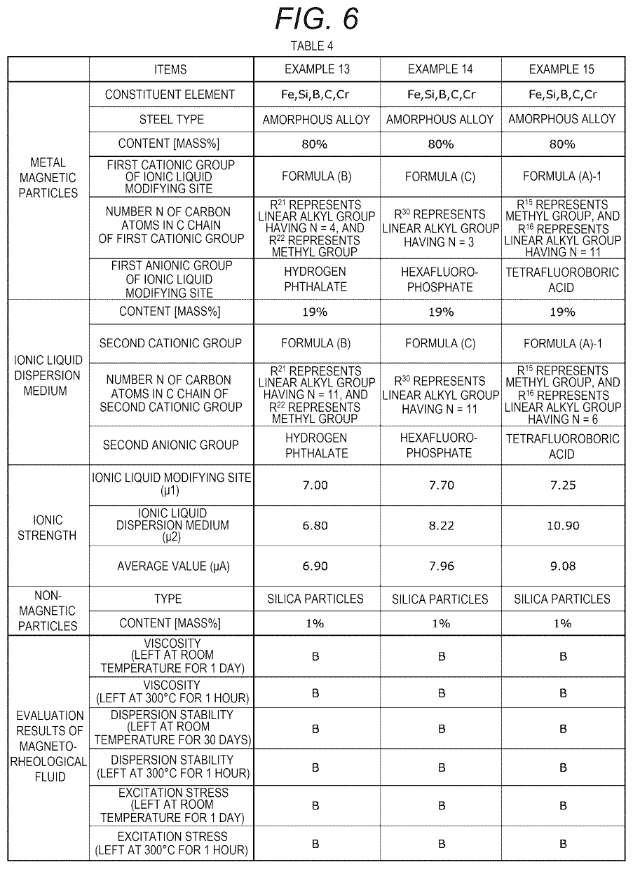

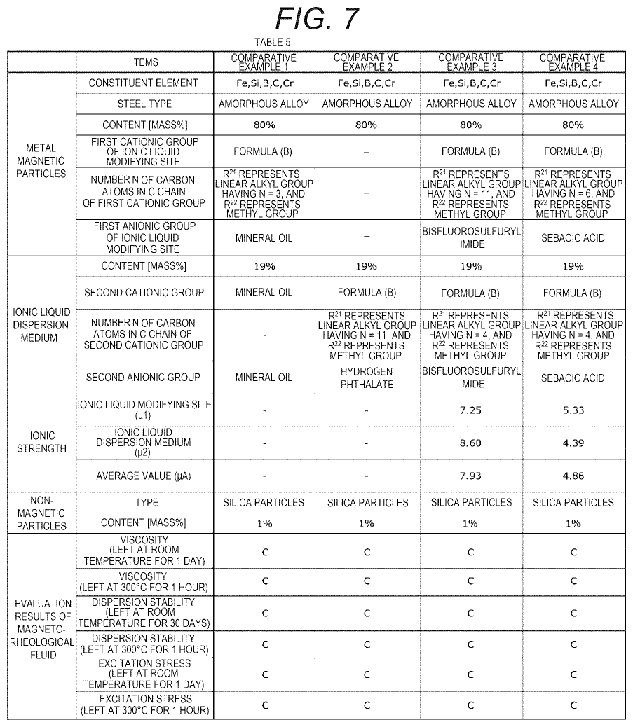

FIGS. 3 to 8 are Tables 1 to 6 indicating preparation conditions and evaluation results of the magnetorheological fluid.

The magnetorheological fluid was prepared as follows.

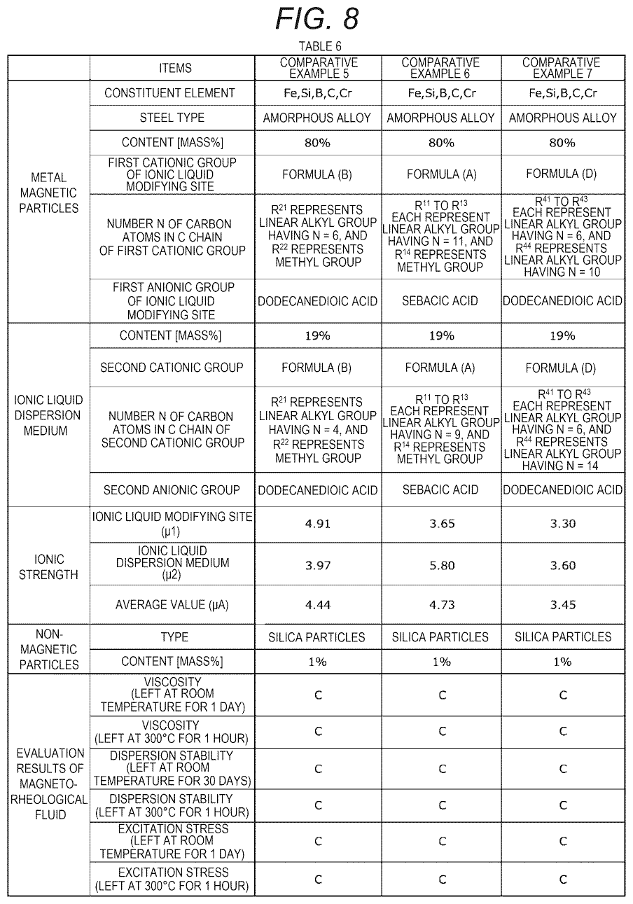

First, the metal magnetic particles, the non-magnetic particles, and the ionic liquid dispersion medium illustrated in Table 1 (FIG. 3) to Table 6 (FIG. 8) were mixed. The average particle diameter of the metal magnetic particle was 8 μm, and the average particle diameter of the non-magnetic particle was 40 nm. The respective contents of the metal magnetic particles and the non-magnetic particles, and the ionic strength (unit: mol/L) of the ionic liquid are as illustrated in Tables 1 to 6. The remainder of the content was the ionic liquid dispersion medium.

Next, the obtained mixture was stirred. A high shear mixer (Silverson, L5M-A) was used as a stirring device. The stirring conditions were a rotation speed of 3000 rpm and a stirring time of 30 minutes. Accordingly, the magnetorheological fluids of Examples 1 to 15 and Comparative Examples 1 to 7 were prepared.

Each of the comparative examples is the following magnetorheological fluid.

Comparative Example 1: Mineral oil was used as the dispersion medium.

Comparative Example 2: Surface modification by the ionic liquid modifying site was omitted.

Comparative Example 3: The first cationic group and the second cationic group are different from each other.

Comparative Example 4: The first anionic group and the second anionic group are other than specific ions.

Comparative Example 5: The first anionic group and the second anionic group are other than specific ions.

Comparative Example 6: The first anionic group and the second anionic group are other than specific ions.

Comparative Example 7: The first anionic group and the second anionic group are other than specific ions.

A “C chain of cationic group” in Tables 1 to 6 refers to an alkyl group bonded to the main skeleton of a cationic group.

### 5. Evaluation of Magnetorheological Fluid

The viscosity, the dispersion stability, and the excitation stress of the magnetorheological fluid of each of examples and comparative examples were evaluated at a room temperature and at a high temperature.

### 5.1. Viscosity

The viscosity of the magnetorheological fluid of each of examples and comparative examples was measured at a non-magnetic field (at a magnetic flux density of 0 T). To measure the viscosity, a rheometer MCR102 manufactured by Anton Paar was used. The shear rate at the time of measurement was 0.033/s.

The viscosity of the magnetorheological fluid left at a temperature of 25° C. for 1 day was measured under the above measurement conditions, and a measurement value was set to a “viscosity (left at room temperature for 1 day)”. The viscosity of the magnetorheological fluid heated at a temperature of 300° C. for 1 hour was measured in the same manner, and a measurement value was set to a “viscosity (left at 300° C. for 1 hour)”.

Then, the obtained viscosity was evaluated in view of the following evaluation criteria. The evaluation results are illustrated in Tables 1 to 6.
A: The viscosity is less than 10000 mPa·s.
B: The viscosity is 10000 mPa·s or more and less than 100000 mPa·s.
C: The viscosity is 100000 mPa·s or more.

### 6.2. Dispersion Stability

The dispersion stability of the magnetorheological fluid of each of examples and comparative examples was evaluated by the following method.

First, 1 mL of the magnetorheological fluid was placed in a 1.5 mL sample bottle. After being left at a temperature of 25° C. for 24 hours, a thickness tA of a phase-separated metal magnetic particle-containing layer (a precipitation layer) and a thickness tB of an ionic liquid dispersion medium layer (a supernatant layer) were measured. The thickness of the metal magnetic particle-containing layer is the thickness of the layer formed of the precipitated metal magnetic particles, and the thickness of the ionic liquid dispersion medium layer is the thickness from an upper end of the metal magnetic particle-containing layer to the liquid surface.

Next, a supernatant ratio tB/(tA+tB) was calculated based on the thicknesses tA and tB.

Then, the supernatant ratio of the magnetorheological fluid left at a temperature of 25° C. for 30 days was calculated by the above calculation method, and a calculation result was defined as “dispersion stability (left at room temperature for 30 days)”. The supernatant ratio of the magnetorheological fluid heated at a temperature of 300° C. for 1 hour was calculated by the above calculation method, and a calculation result was defined as “dispersion stability (left at 300° C. for 1 hour)”.

Then, the dispersion stability of the magnetorheological fluid was evaluated by comparing the calculated supernatant ratio with the following evaluation criteria.

The evaluation results are indicated in Tables 1 to 6. It is indicated that the smaller the supernatant ratio is, the higher the dispersion stability of the metal magnetic particles in the magnetorheological fluid is.
AA: The supernatant ratio is less than 10%.
A: The supernatant ratio is 10% or more and less than 30%.
B: The supernatant ratio is 30% or more.
C: The supernatant ratio cannot be calculated due to gelation.

### 5.3. Excitation Stress

The excitation stress of the magnetorheological fluid of each of examples and comparative examples was evaluated by the above method.

The excitation stress of the magnetorheological fluid left at a temperature of 25° C. for 1 day was measured, and a measurement result was set to an “excitation stress (left at room temperature for 1 day)”. The excitation stress of the magnetorheological fluid heated at a temperature of 300° C. for 1 hour was measured, and a measurement result was set to an “excitation stress (left at 300° C. for 1 hour)”.

Then, the measured excitation stress was evaluated in view of the following evaluation criteria. The evaluation results are indicated in Tables 1 to 6.
AA: The excitation stress is 20 kPa or more.
A: The excitation stress is 15 kPa or more and less than 20 kPa.
B: The excitation stress is 10 kPa or more and less than 15 kPa.
C: The excitation stress is less than 10 kPa.

As is clear from Tables 1 to 6, each of the evaluation results of the viscosity, the dispersion stability, and the excitation stress in the magnetorheological fluid of each example was B or more, which was a satisfactory result. The boiling point of the magnetorheological fluid of each example was all 250° C. or higher, and the freezing point was 0° C. or lower.

In contrast, in the magnetorheological fluid of each comparative example, each evaluation result was poor.

When the average particle diameter of the metal magnetic particle was changed to 5 μm, 12 μm, and 15 μm and the same experiment as described above was performed, evaluation results with similar tendencies as above were obtained.

A magnetorheological fluid obtained by removing the non-magnetic particles from the magnetorheological fluid of Example 9 was separately prepared, and the same experiment as described above was performed. As a result, the same evaluation results as those in Example 9 were obtained except that the evaluation results about the dispersion stability and the excitation stress became A.

From the above results, according to the present disclosure, it is possible to achieve a magnetorheological fluid capable of achieving both high reliability and high excitation stress even when being used at a low temperature or a high temperature.

What is claimed is:

1. A magnetorheological fluid comprising:
a metal magnetic particle having a surface modified with an ionic liquid modifying site having a first cationic group and a first anionic group; and
an ionic liquid dispersion medium having a second cationic group and a second anionic group, wherein
the first cationic group and the second cationic group are same kind of cation and are selected from the group including a quaternary ammonium ion, an imidazolium ion, a pyridinium ion, and a phosphonium ion, and
the first anionic group and the second anionic group are each selected from the group including a tetrafluoroborate ion, a hexafluorophosphate ion, a trispentafluoroethyl trifluorophosphate ion, a bis(trifluoromethanesulfonyl)amide ion, a hydrogen phthalate ion, and a bisfluorosulfuryl imide ion.

2. The magnetorheological fluid according to claim 1, wherein
the first cationic group and the second cationic group are cations represented by the following formulae (A)-3, (A)-4, (B)-1, and (C)-1, 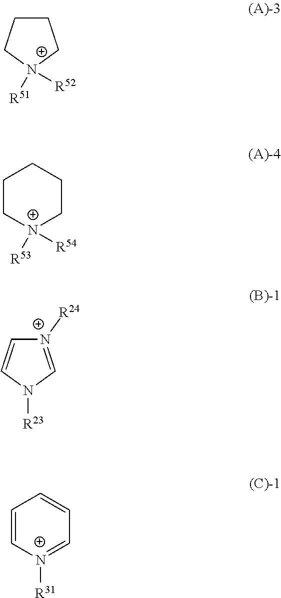
in the formula (A)-3, R⁵¹ represents an alkyl group having 2 carbon atoms, and R⁵² represents an alkyl group having 1 or more and 2 or less carbon atoms, in the formula (A)-4, R⁵³ represents an alkyl group having 2 carbon atoms, and R⁵⁴ represents an alkyl group having 1 or more and 2 or less carbon atoms, in the formula (B)-1, R²³ represents an alkyl group having 2 carbon atoms, and R²⁴ represents an alkyl group having 1 or more and 2 or less carbon atoms, and in the formula (C)-1, R³¹ represents an alkyl group having 1 or more and 2 or less carbon atoms.

3. The magnetorheological fluid according to claim 1, wherein
the first cationic group and the second cationic group each have alkyl groups bonded to a main skeleton thereof, and
when among the alkyl groups bonded to the main skeleton of the first cationic group, an alkyl group having the largest number of carbon atoms is defined as a first long-chain alkyl group, and among the alkyl groups bonded to the main skeleton of the second cationic group, an alkyl group having the largest number of carbon atoms is defined as a second long-chain alkyl group,
the number of carbon atoms of the first long-chain alkyl group and the number of carbon atoms of the second long-chain alkyl group are same.

4. The magnetorheological fluid according to claim 1, wherein
the first anionic group and the second anionic group are tetrafluoroborate ions.

5. The magnetorheological fluid according to claim 1, wherein
an average particle diameter of the metal magnetic particle is 0.5 μm or more and 15 μm or less.

6. The magnetorheological fluid according to claim 1, wherein
an average value of an ionic strength of the ionic liquid modifying site and an ionic strength of the ionic liquid dispersion medium is 5.00 mol/L or more and 14.00 mol/L or less.

7. The magnetorheological fluid according to claim 1, further comprising:
a non-magnetic particle having an average particle diameter less than an average particle diameter of the metal magnetic particle.

8. The magnetorheological fluid according to claim 7, wherein
a material forming the non-magnetic particle is an inorganic material.

9. The magnetorheological fluid according to claim 7, wherein
a content of the non-magnetic particle is 0.01 mass % or more and 5 mass % or less.

10. The magnetorheological fluid according to claim 1, wherein
a yield stress of the magnetorheological fluid when a magnetic field of 1.0 T is applied after being left in an environment at a temperature of 300° C. for 1 hour is 15 kPa or more.

11. The magnetorheological fluid according to claim 1, wherein
the first anionic group and the second anionic group are same kind of anion.

12. A braking device comprising
a fixed portion;
a movable portion movable with respect to the fixed portion;
the magnetorheological fluid according to claim 1 held between the fixed portion and the movable portion; and
a magnetic field generation unit configured to apply a magnetic field to the magnetorheological fluid.
